(19) United States
(12) Patent Application Publication
(10) Pub. No.: US 2017/0096564 A1
(43) Pub. Date: Apr. 6, 2017

(54) COATING COMPOSITION WITH ANTICORROSION EFFECT

(71) Applicant: BASF Coatings GmbH, Muenster (DE)

(72) Inventors: Dirk SEEGER, Oldenburg (DE); Martin KAUNE, Oldenburg (DE); Hubert THEIL, Shanghai (CN); Nadine HOMANN, Oldenburg (DE); Christoph PIECHA, Stadland (DE); Justina MUEHLMEYER, Bad Iburg (DE)

(73) Assignee: BASF Coatings GmbH, Muenster (DE)

(21) Appl. No.: 15/315,937

(22) PCT Filed: Apr. 23, 2015
(86) PCT No.: PCT/EP2015/058780

§ 371 Date: Dec. 2, 2016

(30) Foreign Application Priority Data
Jun. 5, 2014 (EP) 14171249.7

(51) Int. Cl. C09D 5/10; C09D 5/08; C09D 163/00; C09D 7/12; B05D 1/18; B63B 59/00; B05D 1/04; B05D 3/10; B05D 5/00; B05D 7/14; B05D 7/00; B64D 45/00; C09D 5/12; B05D 1/28

(52) U.S. Cl. CPC C09D 5/106; C09D 5/12; C09D 5/084; C09D 163/00; C09D 7/1291; B05D 1/18; B05D 1/28; B05D 1/04; B05D 3/108; B05D 5/00; B05D 7/14; B05D 7/52; B64D 45/00; B63B 59/00

(57) ABSTRACT

The present invention relates to a coating composition comprising at least one binder (A) comprising at least one polymeric resin (A1) and at least one crosslinking agent (A2), at least one anticorrosion pigment (B), and at least one organic solvent (C), where (B) is an alloy of Zn and Mg and optionally at least one further metal and/or semimetal, the coating composition having a pigment volume concentration (PVC) in a range from 5.0% to 25.0%, and comprising the anticorrosion pigment (B) in an amount in a range from 5.0 to 25.0 wt %, based on the total weight of the coating composition, to the use thereof for the at least partial coating of a metallic substrate with a primer coat, to a method for the at least partial coating of such a substrate with such a primer coat, to a substrate at least partially coated therewith, and to a component or article produced from such a substrate.

The present invention relates to a coating composition comprising at least one binder (A) comprising at least one polymeric resin (A1) and at least one crosslinking agent (A2), at least one anticorrosion pigment (B), and at least one organic solvent (C), where (B) is an alloy of Zn and Mg and optionally at least one further metal and/or semimetal, the coating composition having a pigment volume concentration (PVC) in a range from 5.0% to 25.0%, and comprising the anticorrosion pigment (B) in an amount in a range from 5.0 to 25.0 wt %, based on the total weight of the coating composition, to the use thereof for the at least partial coating of a metallic substrate with a primer coat, to a method for the at least partial coating of such a substrate with such a primer coat, to a substrate at least partially coated therewith, and to a component or article produced from such a substrate.

In many fields, such as the field of aircraft construction and of marine travel, for example, and also in the case of large-scale technical mechanical systems such as wind energy systems, it is customarily necessary to protect the respective metallic components used, especially components made of aluminum and/or aluminum alloys, against corrosion. The requirements imposed on the corrosion prevention that is to be obtained are very high, especially since the manufacturers often offer a guarantee against rust penetration over many years. In the air travel field in particular, furthermore, the requirements imposed on corrosion prevention are very strict. Such corrosion prevention is customarily achieved by coating the components, or the subtrates used for producing them, with at least one coating suitable for the purpose.

In order to obtain sufficient corrosion protection for metallic substrates such as aluminum or aluminum alloys or else ungalvanized or galvanized steels, it is customary to use anticorrosion pigments based on chromium-containing compounds such as chromate, which, while affording good corrosion prevention, are nevertheless deleterious on health and environmental grounds, by virtue of their toxicity.

WO 2011/058021 A1 discloses coating compositions which comprise anticorrosion pigments. The anticorrosion pigments are alloys consisting exclusively of zinc and magnesium. WO 2014/029779 A2 and WO 2014/029781 A2 also disclose coating compositions which feature anticorrosion pigments, which in turn comprise at least zinc and magnesium.

A disadvantage of the coating compositions known from WO 2011/058021 A1 is that the coating compositions disclosed therein have a comparatively high anticorrosion pigment content: the fraction of anticorrosion pigments, based on the total weight of the exemplary coating compositions in WO 2011/058021 A1, is more than 80 wt %, and the coating compositions have a pigment volume concentration (PVC)>65%. The fraction of the anticorrosion pigments which are disclosed in the exemplary coating compositions in WO 2014/029779 A2 and WO 2014/029781 A2 is comparatively high as well, at >30 wt %. A particular disadvantage of these known coating compositions is that substrates coated using them have unsatisfactory adhesion properties to overlying coatings such as topcoat coatings, for example, and there may therefore be unwanted delamination, especially under exposure to loading.

A need exists for coating compositions for the at least partial coating of substrates, especially metallic substrates, with a primer coat that allow a more economic and more environmental coating method than conventional coating compositions used, especially in relation to the replacement of conventional coating compositions, but which nevertheless are at least equally suitable for achieving the requisite anticorrosion effect, yet without exhibiting any disadvantages at all in terms of their adhesion properties after corresponding coating of substrates, particularly with regard to the adhesion to other, overlying coats.

It is an object of the present invention, therefore, to provide a coating composition for the at least partial coating of a preferably metallic substrate with a primer coat that has advantages over the coating compositions known from the prior art. A particular object of the present invention is to provide coating compositions of this kind which allow a more environmental coating method than conventional coating compositions used—that is, which make it possible, for example, to forego the chromating procedure that must customarily be carried out, using strontium chromate, for example, but with which it is nevertheless possible to obtain at least the same, and more particularly an improved or at least equal, anticorrosion effect, and with which, furthermore, it is possible to achieve effective adhesion of the substrate coated accordingly to other, overlying coatings.

This object is achieved by the subject matter claimed in the claims, and also by the preferred embodiments of said subject matter that are described in the description hereinafter.

A first subject of the present invention is therefore a coating composition comprising

at least one binder (A) comprising at least one polymeric resin (A1) and at least one crosslinking agent (A2),

at least one anticorrosion pigment (B), and

at least one organic solvent (C), and optionally at least one further component (D),

for at least partial coating of a metallic substrate with a primer coat, wherein
the anticorrosion pigment (B) is an alloy of zinc (Zn) and magnesium (Mg) and optionally at least one further metal and/or semimetal, and comprises zinc in an amount of at least 70 wt %, magnesium in an amount of at least 20 wt %, and the optionally present at least one further metal and/or semimetal in an amount of at most 10 wt %, based in each case on the total weight of the anticorrosion pigment (B), where the amounts in % by weight of zinc, of magnesium, and of the optionally present at least one further metal and/or semimetal that are present in the anticorrosion pigment (B) add up in total to 100 wt %,
the coating composition has a pigment volume concentration (PVC) in a range from 5.0% to 25.0%, and wherein
the coating composition comprises the anticorrosion pigment (B) in an amount in a range from 5.0 to 25.0 wt %, based on the total weight of the coating composition.

The coating composition of the invention serves accordingly for producing a primer coat on a surface of a preferably metallic substrate.

It has surprisingly been found that the coating composition of the invention, especially when used in a method for the at least partial coating of a substrate with a primer coat, makes it possible to forgo a chromating process on the substrate employed, such a process being, in particular, objectionable from a toxicological standpoint and customarily required in the aircraft construction field; as a result, the corresponding coating method can overall be made more environmental and more economic than conventional methods.

In particular it has surprisingly been found that the coating composition of the invention makes it possible to provide substrates which are coated at least partially with a primer coat and which, in comparison to substrates coated using conventionally employed coating compositions, have at least no disadvantages, and more particularly have advantages, in terms of their anticorrosion effect.

It has further surprisingly been found that the coating composition of the invention, on application to a substrate, permits a homogeneous coating. Here, even the at least one, preferably platelet-shaped, anticorrosion pigment (B) is distributed homogeneously in the coating. Moreover, it has surprisingly been found that the coating composition of the invention is notable for an improved oxygen and/or moisture barrier effect relative to coating compositions known from the prior art, and is also readily recoatable.

Surprisingly it has additionally been found that coating compositions of the invention that are applied to a suitable substrate exhibit very good adhesion to further, overlying coatings such as a topcoat applied over them, and that there is no delamination of any such coating applied over them, such as a topcoat, from the substrate coated with the coating composition of the invention, more particularly even under load exposures, this being attributable in particular to the specific pigment volume concentration (PVC) range of 5.0% to 25.0% and/or to a specific amount of the anticorrosion pigment (B) in a range from 5.0 to 25.0 wt %, based on the total weight of the coating composition: corresponding comparative coating compositions with a higher anticorrosion pigment content >25 wt % and/or a PVC>25%, as per WO 2014/029779 A2 and WO 2014/029781 A2, for example, have disadvantages in these respects.

The term “comprising” in the sense of the present invention, in connection for example with the coating composition of the invention, has in one preferred embodiment the meaning of “consisting of”. In this case, with regard to the coating composition of the invention, in this preferred embodiment, besides the components (A), (B), and (C), there may be one or more of the further components present in the coating composition that are identified below and are optionally present in the coating composition of the invention, such as, for example, one or more of components (D). All of the components, in each case in one of their preferred embodiments as specified below, may be present in the coating composition of the invention.

### Substrate

Suitable substrates used in accordance with the invention include all substrates customarily used and known to the skilled person, more particularly metallic substrates. The substrates used in accordance with the invention are preferably selected from the group consisting of iron, steel, aluminum, or alloys thereof, more particularly of aluminum-based alloys, it being possible for these alloys to have optionally at least one further metal and/or semimetal, such as copper, for example. Preferably the substrates here each have at least one surface of iron, steel, aluminum, or alloys thereof, and more preferably they consist entirely of iron, steel, aluminum, or alloys thereof. Suitable steel is preferably steel selected from the group consisting of cold-rolled steel, hot-rolled steel, high-strength steel, galvanized steel such as dip-galvanized steel, alloy-galvanized steel (such as Galvalume®, Galvannealed®, or Galfan®, for example), and aluminized steel. Examples of suitable alloys are aluminum-copper alloys. Especially preferred are substrates made of aluminum or alloys containing aluminum.

The substrates used may here in particular be parts of components employed in aircraft construction for the construction of an aircraft. The use of the substrate in question is preferably preceded by its cleaning and/or degreasing.

Before being coated with the coating composition of the invention, the preferably metallic substrate used in accordance with the invention may be pretreated with a suitable, preferably aqueous, pretreatment composition. Such pretreatment compositions are known to the skilled person and are available commercially. For example, substrates of aluminum, based on aluminum or on an alloy containing aluminum can be pretreated by means of tartaric-sulfuric acid anodizing (TSA) as per DIN EN 4704 (date: May 2012). Substrates of steel or based on steel may be pretreated by means of a pretreatment as per DIN EN ISO 12944-4 (date: July 1998), for example. The grade of the steel or steel-based substrates used is preferably at least 2.5. Steel grade may be determined as per DIN EN ISO 8501-1 (date: December 2007).

### Coating Composition

The coating composition of the invention is preferably in the form of a dispersion or solution, more particularly in the form of a dispersion.

The fractions in weight % of all of the components present in the coating composition of the invention, in other words of components (A) including (A1) and (A2), (B), and (C), and also optionally (D), add up in each case to 100 wt %, based on the total weight of the coating composition of the invention.

The coating composition of the invention is preferably chromium-free, meaning that it contains no chromium-containing compounds, more particularly no chromate-containing compounds.

The coating composition of the invention is preferably a solvent-based, i.e., nonaqueous, coating composition.

The term “solvent-based” or “nonaqueous” in connection with the coating composition of the invention means preferably, in the sense of the present invention, a corresponding coating composition which as its liquid dilution medium, i.e., as liquid solvent and/or dispersion medium, comprises at least one organic solvent as principal component (in terms of the dilution media employed), more particularly the at least one component (C). The fraction of organic solvents in the coating composition of the invention, more particularly of component (C), is preferably at least 95.0 wt % or at least 96.0 wt % or at least 97.0 wt %, more preferably at least 97.5 wt % or at least 98.0 wt % or at least 98.5 wt %, most preferably at least 99 wt % or at least 99.5 wt % or at least 99.9 wt %, based in each case on the total fraction of the liquid dilution media present in the coating composition.

The coating composition of the invention is preferably a primer coating composition, i.e., a coating composition which is suitable for producing a primer coat. The term “primer” is known to the skilled person and is defined for example in Rompp Lexikon, Lacke and Druckfarben, Georg Thieme Verlag 1998.

The coating composition of the invention preferably has a nonvolatile fraction in the range from 30 to 70 wt %, more preferably in the range from 35 to 65 wt %, very preferably in the range from 40 to 65 wt %, more particularly from 45 to 60 wt %, most preferably from 50 to 60 wt %, based in each case on the total weight of the coating composition.

The skilled person is aware of determination methods for ascertaining the nonvolatile fraction. The determination is made in accordance with the method described later on.

The coating composition of the invention has a pigment volume concentration (PVC) in a range from 5.0% to 25.0%. The skilled person is familiar with the concept of the pigment volume concentration (PVC). This term is defined in DIN EN ISO 4618 (date: March 2007). The pigment volume concentration (PVC) identifies the ratio of the volume of the pigments and fillers present in the coating composition to the total volume of nonvolatile constituents in the coating composition, i.e., more particularly, the ratio of the volume of the pigments and fillers present in the coating composition to the total volume of nonvolatile constituents of the pigments and fillers and binders present in the coating composition, multiplied in each case by a factor of 100.

The coating composition of the invention preferably has a pigment volume concentration (PVC) in a range from 5.0% to 22.5%, more preferably in a range from 5.0% to 20.0%, very preferably in a range from 5.0% to 17.5%, more preferably still in a range from 5.0% to 15.0%, including a range from 7.5% to 15.0%, very preferably in a range from 7.5% to 15.0%, more particularly in a range from 6.5% to 13%.

### Binder (A)

The coating composition of the invention comprises at least one binder (A) comprising at least one polymeric resin (A1) and at least one crosslinking agent (A2).

The term “binder” refers in the sense of the present invention, in accordance with DIN EN ISO 4618 (German version, date: March 2007), preferably to those nonvolatile fractions of a coating composition—such as of the coating composition of the invention—that are preferably responsible for film formation. Pigments included in the composition, including the at least one anticorrosion pigment (B) and any further pigments and fillers present, are therefore not subsumed by the term “binder”. The nonvolatile fraction may be determined in accordance with DIN EN ISO 3251 (date: June 2008) by the method described later on. In particular, the term “binder” comprehends the polymeric resins (A1) that are present in the coating composition and are responsible for film formation. The term “binder” further encompasses crosslinking agent that is present in the coating composition, such as component (A2), for example.

The coating composition of the invention is preferably prepared using a dispersion or solution, more preferably at least one dispersion, which comprises the at least one polymeric resin (A1). To prepare the coating composition of the invention, preference is given to using at least one dispersion or solution, more preferably at least one dispersion, of at least one crosslinking agent (A2), which is combined shortly before the coating composition is prepared with the solution or dispersion containing (A1) (2-component coating composition).

All customary binders known to the skilled person are suitable here as binder (A) of the coating composition of the invention.

The binder (A) preferably comprises at least one polymeric resin (A1) which has reactive functional groups that permit a crosslinking reaction. This polymeric resin (A1) is preferably an externally crosslinking polymeric resin. In order to allow a crosslinking reaction, the binder (A), as well as the at least one polymeric resin (A1), also comprises at least one crosslinking agent (A2).

The polymeric resin present in the binder (A1) and/or the at least one crosslinking agent (A2) also present are preferably crosslinkable thermally, as for example by physical drying, and are preferably crosslinkable on heating to oven temperatures at or above 18-23° C.

Any customary crosslinkable reactive functional group known to the skilled person is contemplated as a crosslinkable reactive functional group of the polymeric resin (A1) here. The polymeric resin (A1) preferably has at least one kind of functional reactive groups selected from the group consisting of primary amino groups, secondary amino groups, hydroxyl groups, thiol groups, carboxyl groups, groups which have at least one C═C double bond, such as vinyl groups or (meth)acrylate groups, for example, and epoxide groups, and also mixtures thereof. Preference is given to hydroxyl groups, carboxyl groups and/or epoxide groups, more particularly epoxide groups.

For the purposes of the present invention, the expression “(meth)acryloyl” or “(meth)acrylate” encompasses in each case the definitions “methacryloyl” and/or “acryloyl”, or “methacrylate” and/or “acrylate”, respectively.

The polymeric resin of the binder (A) preferably has a fraction of crosslinkable reactive functional groups such as epoxide groups in the range from 0.15 wt % to 3.5 wt %, more preferably from 0.25 to 3.0 wt %, very preferably from 0.50 to 2.5 wt %, more particularly from 1.0 to 2.0 wt %, based in each case on the total weight of the solids content of the polymeric resin (A1).

The at least one polymeric resin (A1) of the at least one binder (A) is preferably curable thermally in the presence of the at least one crosslinking agent (A2), and is preferably crosslinkable at temperatures in the range from 25° C. to 80° C. Alternatively, such curing may take place even at room temperature, i.e., at a temperature in the range from 18° C. to 23° C. Alternatively, such curing may not take place until higher temperatures, as for example at temperatures ≧80° C., ≧110° C., ≧140° C., or ≧170° C.

The binder (A) preferably comprises at least one polymeric resin (A1) selected from the group consisting of polyurethanes, polyesters, polyamides, polyureas, polystyrenes, polycarbonates, poly(meth)acrylates, vinyl ester-based resins, epoxy resins, phenol-formaldehyde resins, melamine-formaldehyde resins, phenolic resins, and silicone resins, and also mixtures thereof, with preferably 70 to 100 wt % of the polymeric resin being selected from at least one of the aforementioned polymers. The stated polymers are preferably understood in each case to include not only homopolymers but also corresponding copolymers.

The binder (A) preferably comprises at least one polymeric resin (A1) selected from the group consisting of epoxy resins, with preferably 70 to 100 wt % of the polymeric resin (A1) of the binder (A) being selected from at least one such epoxy resin. Epoxy resins of this kind are known to the skilled person. Such epoxy resins preferably have at least two epoxide groups, which are in each case preferably terminal groups. Particularly preferred epoxy resins here are polyglycidyl ethers of polyphenols that are prepared from polyphenols and epihalohydrins. Polyphenols used may include, in particular, bisphenol A and/or bisphenol F. Other suitable polyepoxides are polyglycidyl ethers of polyhydric alcohols, such as ethylene glycol, diethylene glycol, triethylene glycol, 1,2-propylene glycol, 1,4-propylene glycol, 1,5-pentanediol, 1,2,6-hexanetriol, glycerol, and 2,2-bis(4-hydroxycyclohexyl)propane. Suitable by way of example are the commercially available products Epoxy Novolac® or D.E.N.® such as, for example, D.E.N.® 438-X80, or Polypox® such as Polypox® R19 from Dow Chemicals, and/or the commercially available Araldite® products from Huntsman, such as Araldite® EPN 1180, Araldite® EPN 1180 X-80, or Araldite® DY 3601, for example, as polymeric epoxy resins (A1) which can be used.

The polymeric resin (A1) preferably has an epoxide value in a range from 175 to 450, more preferably in a range from 200 to 400. The epoxide value indicates the number of moles of epoxide groups that are present in 100 grams of polymeric resin (A1). The epoxide value can be calculated from the epoxide equivalent weight of the polymeric resin (A1) (epoxide value=100/epoxide equivalent weight). The epoxide equivalent weight is the mass of the polymeric resin (A1) which contains exactly 1 mol of epoxide groups. The epoxide equivalent weight is determined preferably in accordance with DIN EN ISO 3001 (date: November 1999).

Suitable crosslinking agents (A2) are all customary crosslinking agents known to the skilled person, such as, for example, polyamines, aminoplast resins, phenoplast resins, polyfunctional Mannich bases, melamine resins, benzoguanamine resins, beta-hydroxyalkylamides, tris(alkoxycarbonylamino)triazines, free polyisocyanates and/or blocked polyisocyanates, and also compounds having on average at least two groups capable of transesterification, examples being reaction products of malonic diesters and polyisocyanates, or of esters, including partial esters, of polyhydric alcohols of malonic acid with monoisocyanates. A particularly preferred crosslinking agent is a polyamine, i.e., an amine having at least two amino groups, which preferably are selected from the group consisting of primary and secondary amino groups. Preferably 70 to 100 wt % of the crosslinking agent (A2) are selected from at least one polyamine. The crosslinking agent (A2) here may comprise two or more different polyamines.

The binder (A) preferably comprises at least one polymeric resin (A1), more particularly at least one epoxy resin, which is crosslinked or cured with participation by amino groups. Accordingly, the at least one crosslinking agent (A2) preferably has at least functional amino groups. With particular preference, therefore, at least one polyamine is used as crosslinking agent (A2). Polyamines having functional amino groups are known to the skilled person. Suitable examples are the commercially available Aradur® products such as Aradur® 3204XW29 or Aradur® 115 BD, for example, or such as Cardolite®, an example being Cardolite® NC 562, as crosslinking agents (A2) that can be used.

The crosslinking agent (A2) preferably has an amine number in a range from 50 to 150, more preferably in a range from 65 to 120. The amine number is determined preferably in accordance with DIN EN ISO 9702 (date: October 1998). Alternatively or additionally (in the presence of at least two crosslinking agents (A2) different from one another) said agent may have an amine number in a range from 160 to 300, more preferably in a range from 170 to 280.

In order to accelerate the crosslinking, suitable catalysts may be added to the coating composition. Such catalysts as well are known to the skilled person. For example, the commercially available Ancamine® K54 product can be used.

Preferably the relative weight ratio of the at least one polymeric resin (A1) to the at least one crosslinking agent (A2) in the coating composition of the invention is in a range from 4:1 to 1:1, more preferably in a range from 3:1 to 1:1, very preferably in a range from 2.5:1 to 1:1, more particularly in a range from 2.2:1 to 1:1, most preferably in a range from 1.8:1 to 1:1, based in each case on the solids fraction of the at least one polymeric resin (A1) and of the at least one crosslinking agent (A2) within the coating composition of the invention. Alternatively, the relative weight ratio of the at least one polymeric resin (A1) to the at least one crosslinking agent (A2) in the coating composition of the invention is preferably in a range from 4:1 to 1:0.9, more preferably in a range from 3:1 to 1:0.9, very preferably in a range from 2.5:1 to 1:0.9, most particularly in a range from 2.2:1 to 1:0.9, most preferably in a range from 1.8:1 to 1:0.9, based in each case on the solids fraction of the at least one polymeric resin (A1) and of the at least one crosslinking agent (A2) within the coating composition of the invention.

Based on the solids content of the binder (A), the coating composition of the invention preferably comprises the binder (A) in an amount of 10 to 55 wt %, more preferably in an amount of 15 to 50 wt %, very preferably in an amount of 18 to 45 wt %, especially preferably in an amount of 20 to 40 wt %, based on the total weight of the coating composition.

The binder (A) preferably comprises at least one polymeric epoxy resin (A1) and at least one crosslinking agent (A2) having at least functional amino groups.

The binder (A) preferably comprises at least two different polymeric epoxy resins (A1) and/or at least two different crosslinking agents (A2) having at least functional amino groups.

The at least one crosslinking agent (A2) preferably, moreover, has functional silane groups. Alternatively or additionally, moreover, at least one additive having silane groups may be added to the coating composition of the invention.

### Anticorrosion Pigment (B)

The coating composition of the invention comprises the at least one anticorrosion pigment (B) in an amount in a range from 5.0 to 25.0 wt %, based on the total weight of the coating composition.

The coating composition of the invention preferably comprises the at least one anticorrosion pigment (B) here in an amount in a range from 5.0 to <20.0 wt %, more preferably in a range from 5.0 to 17.5 wt %, very preferably in a range from 5.0 to 15.0 wt %, more preferably still in a range from 6.0 to 14.0 wt %, based in each case on the total weight of the coating composition.

The relative weight ratio of the anticorrosion pigment (B) to other, different pigments and fillers that are optionally present in the coating composition, being possibly present, for example, as component(s) (D) in the coating composition, is preferably in a range from 25:1 to 1:5, more preferably in a range from 20:1 to 1:3 or in a range from 20:1 to 1:1, very preferably in a range from 18:1 to 1:2 or in a range from 18:1 to 1:1.

Preferably the relative weight ratio of the at least one binder (A), based on the solids fraction of the binder (A) in the coating composition, to the at least one anticorrosion pigment (B) in the coating composition is in a range from 5:1 to 1.5:1, more preferably in a range from 4:1 to 1.5:1, very preferably in a range from 3.5:1 to 1.5:1, especially preferably in a range from 3:1 to 1.75:1.

The anticorrosion pigment (B) is an alloy of zinc and magnesium and optionally at least one further metal and/or semimetal, comprising zinc in an amount of at least 70 wt %, magnesium in an amount of at least 20 wt %, and the optionally present at least one further metal and/or semimetal in an amount of at most 10 wt %, based in each case on the total weight of the anticorrosion pigment (B), and the amounts in weight % of zinc, of magnesium, and of the optionally present at least one further metal and/or semimetal that are present in the anticorrosion pigment (B) adding up in total to 100 wt %. The optionally present at least one further metal and/or semimetal serves preferably to increase the ductility of the alloy.

The alloy used as anticorrosion pigment (B) preferably comprises zinc in an amount of at least 71 wt %, more preferably of at least 72 wt %, very preferably of at least 73 wt %, more preferably still of at least 74 wt %, especially preferably of at least 75 wt %, based in each case on the total weight of the anticorrosion pigment (B). The maximum amount of zinc here is preferably in each case 80 wt %, based on the total weight of the anticorrosion pigment (B).

The alloy used as anticorrosion pigment (B) preferably comprises magnesium in an amount of at least 21 wt %, more preferably of at least 22 wt %, very preferably of at least 23 wt %, more preferably still of at least 24 wt %, especially preferably of at least 25 wt %, based in each case on the total weight of the anticorrosion pigment (B). The maximum amount of magnesium here is preferably in each case 30 wt %, based on the total weight of the anticorrosion pigment (B).

The alloy used as anticorrosion pigment (B) preferably comprises the optionally present at least one further metal and/or semimetal in an amount of at most 9.0 wt %, more preferably of at most 8.0 wt %, very preferably of at most 7.0 wt %, more preferably still of at most 6.0 wt %, especially preferably of at most 5.0 wt %, even more preferably of at most 4.0 or 3.0 or 2.0 wt %, most preferably of at most 1.75 or 1.5 or 1.25 wt %, based in each case on the total weight of the anticorrosion pigment (B). The minimum amount of the optionally present at least one further metal and/or semimetal here is preferably in each case 0.1 wt % or 0.5 wt %, based in each case on the total weight of the anticorrosion pigment (B).

The skilled person is familiar with the concept of an “alloy”. Accordingly, the anticorrosion pigment (B) used in accordance with the invention preferably comprises at least one intermetallic phase such as, for example, at least one intermetallic phase of zinc and magnesium (ZnMg), preferably in an amount in a region of at least 30 wt %, as for example in a range from 30 to 50 wt %, more preferably of at least 40 wt %, as for example in a range from 40 to 50 wt %, based on the total weight of the anticorrosion pigment (B).

Preferably the anticorrosion pigment (B) is an alloy of zinc and magnesium and optionally at least one further metal and/or semimetal, comprising zinc in an amount in a range from 70 wt % to 80 wt %, more particularly in a range from 70 wt % to 75 wt %, magnesium in an amount in a range from 20 wt % to 30 wt %, more particularly in a range from 20 wt % to 27.5 wt %, and the optionally present at least one further metal and/or semimetal in an amount in a range from 0.1 to 10 wt % or from 0.1 to 7.5 or 0.1 to 5 wt %, based in each case on the total weight of the anticorrosion pigment (B), and the amounts in weight % of zinc, of magnesium, and of the optionally present at least one further metal and/or semimetal that are present in the anticorrosion pigment (B) adding up in total to 100 wt %.

The skilled person knows of methods for determining the fractions of metals and/or semimetals within an alloy such as the anticorrosion pigment (B), with examples including inductive coupled plasma-atomic emission spectrometry (ICP-OES) in accordance with DIN EN ISO 11885 (date: September 2009).

The molar ratio of zinc to magnesium in the anticorrosion pigment (B) is preferably in a range from preferably 0.75:1 to 1.35:1, more preferably in a range from 0.85:1 to 1.25:1, more preferably still in a range from 0.9:1 to 1.2:1, more particularly in a range from 0.93:1 to 1.15:1.

The anticorrosion pigment (B) is preferably an alloy of zinc and magnesium and at least one further metal and/or semimetal selected from the group consisting of Li, Ce, Be, Y, Ti, Zr, Cr, Mn, Fe, Cu, B, Al, Si, and Sn, and also mixtures thereof, more preferably selected from the group consisting of Li, Ce, Be, Ti, Zr, Mn, Fe, Cu, B, Al, Si, and Sn, and also mixtures thereof. Preferably at least 70 to 100 mol % of the at least one further metal and/or semimetal is selected from the group consisting of Li, Ce, Be, Ti, Zr, Mn, Fe, Cu, B, Al, Si, and Sn, and also mixtures thereof. More particularly the anticorrosion pigment (B) is an alloy of zinc and magnesium and at least one further metal and/or semimetal selected from the group consisting of Li, Ce, Mn, and Si, and also mixtures thereof, with preferably at least 70 to 100 mol % of the at least one further metal and/or semimetal being selected from the group consisting of Li, Ce, Mn, and Si, and also mixtures.

As at least one further metal and/or semimetal the anticorrosion pigment (B) used in accordance with the invention preferably comprises at least Li and/or Ce and/or Be and/or Y and/or Ti and/or Zr and/or Cr and/or Mn and/or Fe and/or Cu and/or B and/or Al and/or Si and/or Sn. In one particularly preferred embodiment, as at least one further metal and/or semimetal, the anticorrosion pigment (B) used in accordance with the invention comprises at least Li and/or Ce and/or Be and/or Ti and/or Mn and/or Fe and/or Cu and/or B and/or Al and/or Si, very preferably at least Mn and/or Al and/or Si. In this case preferably 70 to 100 mol % of the further metal and/or semimetal present within the anticorrosion pigment is formed by Li and/or Ce and/or Be and/or Y and/or Ti and/or Zr and/or Cr and/or Mn and/or Fe and/or Cu and/or B and/or Al and/or Si and/or Sn.

In one preferred embodiment, as at least one further metal and/or semimetal, the anticorrosion pigment (B) used in accordance with the invention comprises at least Ti, preferably in an amount in a range from 0.1 to 1.0 wt %, based on the total weight of the anticorrosion pigment (B), and optionally at least one further metal and/or semimetal selected from the group consisting of Li, Ce, Be, Zr, Mn, Fe, Cu, B, Al, Si, and Sn, and mixtures thereof, with the latter stated at least one further metal and/or semimetal being present therein preferably in an amount in a range from 0.1 to 4.0 wt %, based on the total weight of the anticorrosion pigment (B).

In one preferred embodiment, as at least one further metal and/or semimetal, the anticorrosion pigment (B) used in accordance with the invention comprises at least Li, preferably in an amount in a range from 0.1 to 1.0 wt %, based on the total weight of the anticorrosion pigment (B), and optionally at least one further metal and/or semimetal selected from the group consisting of Ti, Ce, Be, Zr, Mn, Fe, Cu, B, Al, Si, and Sn, and mixtures thereof, with the latter stated at least one further metal and/or semimetal being present therein preferably in an amount in a range from 0.1 to 4.0 wt %, based on the total weight of the anticorrosion pigment (B).

In one preferred embodiment, as at least one further metal and/or semimetal, the anticorrosion pigment (B) used in accordance with the invention comprises at least Ce, preferably in an amount in a range from 0.1 to 1.0 wt %, based on the total weight of the anticorrosion pigment (B), and optionally at least one further metal and/or semimetal selected from the group consisting of Li, Ti, Be, Zr, Mn, Fe, Cu, B, Al, Si, and Sn, and mixtures thereof, with the latter stated at least one further metal and/or semimetal being present therein preferably in an amount in a range from 0.1 to 4.0 wt %, based on the total weight of the anticorrosion pigment (B).

In one preferred embodiment, as at least one further metal and/or semimetal, the anticorrosion pigment (B) used in accordance with the invention comprises at least Be, preferably in an amount in a range from 0.1 to 1.0 wt %, based on the total weight of the anticorrosion pigment (B), and optionally at least one further metal and/or semimetal selected from the group consisting of Li, Ce, Ti, Zr, Mn, Fe, Cu, B, Al, Si, and Sn, and mixtures thereof, with the latter stated at least one further metal and/or semimetal being present therein preferably in an amount in a range from 0.1 to 4.0 wt %, based on the total weight of the anticorrosion pigment (B).

In one preferred embodiment, as at least one further metal and/or semimetal, the anticorrosion pigment (B) used in accordance with the invention comprises at least Zr, preferably in an amount in a range from 0.1 to 1.0 wt %, based on the total weight of the anticorrosion pigment (B), and optionally at least one further metal and/or semimetal selected from the group consisting of Li, Ce, Be, Ti, Mn, Fe, Cu, B, Al, Si, and Sn, and mixtures thereof, with the latter stated at least one further metal and/or semimetal being present therein preferably in an amount in a range from 0.1 to 4.0 wt %, based on the total weight of the anticorrosion pigment (B).

In one preferred embodiment, as at least one further metal and/or semimetal, the anticorrosion pigment (B) used in accordance with the invention comprises at least Mn, preferably in an amount in a range from 0.1 to 1.0 wt %, based on the total weight of the anticorrosion pigment (B), and optionally at least one further metal and/or semimetal selected from the group consisting of Li, Ce, Be, Zr, Ti, Fe, Cu, B, Al, Si, and Sn, and mixtures thereof, with the latter stated at least one further metal and/or semimetal being present therein preferably in an amount in a range from 0.1 to 4.0 wt %, based on the total weight of the anticorrosion pigment (B). This embodiment is particularly preferred.

In one preferred embodiment, as at least one further metal and/or semimetal, the anticorrosion pigment (B) used in accordance with the invention comprises at least Fe, preferably in an amount in a range from 0.1 to 1.0 wt %, based on the total weight of the anticorrosion pigment (B), and optionally at least one further metal and/or semimetal selected from the group consisting of Li, Ce, Be, Zr, Mn, Ti, Cu, B, Al, Si, and Sn, and mixtures thereof, with the latter stated at least one further metal and/or semimetal being present therein preferably in an amount in a range from 0.1 to 4.0 wt %, based on the total weight of the anticorrosion pigment (B).

In one preferred embodiment, as at least one further metal and/or semimetal, the anticorrosion pigment (B) used in accordance with the invention comprises at least Cu, preferably in an amount in a range from 0.1 to 1.0 wt %, based on the total weight of the anticorrosion pigment (B), and optionally at least one further metal and/or semimetal selected from the group consisting of Li, Ce, Be, Zr, Mn, Fe, Ti, B, Al, Si, and Sn, and mixtures thereof, with the latter stated at least one further metal and/or semimetal being present therein preferably in an amount in a range from 0.1 to 4.0 wt %, based on the total weight of the anticorrosion pigment (B).

In one preferred embodiment, as at least one further metal and/or semimetal, the anticorrosion pigment (B) used in accordance with the invention comprises at least B, preferably in an amount in a range from 0.1 to 1.0 wt %, based on the total weight of the anticorrosion pigment (B), and optionally at least one further metal and/or semimetal selected from the group consisting of Li, Ce, Be, Zr, Mn, Fe, Cu, Ti, Al, Si, and Sn, and mixtures thereof, with the latter stated at least one further metal and/or semimetal being present therein preferably in an amount in a range from 0.1 to 4.0 wt %, based on the total weight of the anticorrosion pigment (B).

In one preferred embodiment, as at least one further metal and/or semimetal, the anticorrosion pigment (B) used in accordance with the invention comprises at least Al, preferably in an amount in a range from 0.1 to 1.0 wt %, based on the total weight of the anticorrosion pigment (B), and optionally at least one further metal and/or semimetal selected from the group consisting of Li, Ce, Be, Zr, Mn, Fe, Cu, B, Ti, Si, and Sn, and mixtures thereof, with the latter stated at least one further metal and/or semimetal being present therein preferably in an amount in a range from 0.1 to 4.0 wt %, based on the total weight of the anticorrosion pigment (B).

In one preferred embodiment, as at least one further metal and/or semimetal, the anticorrosion pigment (B) used in accordance with the invention comprises at least Si, preferably in an amount in a range from 0.1 to 1.0 wt %, based on the total weight of the anticorrosion pigment (B), and optionally at least one further metal and/or semimetal selected from the group consisting of Li, Ce, Be, Zr, Mn, Fe, Cu, B, Al, Ti, and Sn, and mixtures thereof, with the latter stated at least one further metal and/or semimetal being present therein preferably in an amount in a range from 0.1 to 4.0 wt %, based on the total weight of the anticorrosion pigment (B).

In one preferred embodiment, as at least one further metal and/or semimetal, the anticorrosion pigment (B) used in accordance with the invention comprises at least Sn, preferably in an amount in a range from 0.1 to 1.0 wt %, based on the total weight of the anticorrosion pigment (B), and optionally at least one further metal and/or semimetal selected from the group consisting of Li, Ce, Be, Zr, Mn, Fe, Cu, B, Al, Si, and Ti, and mixtures thereof, with the latter stated at least one further metal and/or semimetal being present therein preferably in an amount in a range from 0.1 to 4.0 wt %, based on the total weight of the anticorrosion pigment (B).

With particular preference, as at least one further metal and/or semimetal, the anticorrosion pigment (B) used in accordance with the invention comprises at least Mn, preferably in an amount in a range from 0.1 to 1.0 wt %, based on the total weight of the anticorrosion pigment (B), and optionally at least one further metal and/or semimetal selected from the group consisting of Li, Ce, and Si, and mixtures thereof, with the latter stated at least one further metal and/or semimetal being present therein preferably in an amount in a range from 0.1 to 4.0 wt %, based on the total weight of the anticorrosion pigment (B).

With very particular preference, as at least one further metal and/or semimetal, the anticorrosion pigment (B) used in accordance with the invention comprises at least Si, preferably in an amount in a range from 0.1 to 1.0 wt %, based on the total weight of the anticorrosion pigment (B), and optionally at least one further metal and/or semimetal selected from the group consisting of Li and Ce, and mixtures thereof, with the latter stated at least one further metal and/or semimetal being present therein preferably in an amount in a range from 0.1 to 4.0 wt %, based on the total weight of the anticorrosion pigment (B).

The anticorrosion pigment (B) is preferably platelet-shaped. Platelet-shaped anticorrosion pigments are known to the skilled person and are available commercially from Eckart, for example.

The anticorrosion pigment (B) preferably has an average particle size D₅₀ in the range from 1 to 100 μm, more preferably in the range from 1 to 50 μm, including a range from 1 to 40 μm, especially preferably of 1 to 30 μm, most preferably of 5 to 20 μm. Methods for determining the average particle size are known to the skilled person. The average particle size is determined preferably by means of laser diffraction according to ISO 13320-1 (date: October 2009). The average particle size is the D₅₀ volume median, which is determined starting from a dispersion of the anticorrosion pigments (B) whose average particle size is to be ascertained (“wet determination”). The scatter pattern of the sample is compared using a suitable optical model, specifically the Mie theory. The instrument used here is a Mastersizer 2000 from Malvern Instruments. It is controlled using an automated standard operating procedure (SOP).

The anticorrosion pigment (B) preferably has an average platelet thickness in the range from 50 nm to 1000 nm, more preferably from 50 nm to 750 nm, very preferably from 75 nm to 500 nm, more particularly from 100 to 500 nm. The average platelet thickness is determined preferably by means of scanning electron microscopy. Determination of the average platelet thickness takes place preferably in accordance with the method described in DE 10 315 775 A1.

The preparation of anticorrosion pigments (B) used in accordance with the invention is known to the skilled person from, for example, WO 2011/058021 A1, WO 2014/029779 A1 and/or WO 2014/029781 A1: the particles of the anticorrosion pigment (B) used in accordance with the invention are produced preferably by spraying (through nozzles) of an alloy based on zinc and on magnesium and optionally on at least one further metal and/or semimetal and also optionally on at least one lubricant such as stearic acid, for example, under inert gas. These particles may optionally be processed further subsequently by mechanical shaping, by means of a ball mill with agitator mechanism, for example, to form platelet-shaped anticorrosion pigments (B).

### Organic Solvent (C)

The coating composition of the invention comprises, as component (C), at least one organic solvent. The concept of the “organic solvent” is familiar to the skilled person, from Directive 1999/13/EC of Mar. 11, 1999, for example.

All organic solvents known to the skilled person are suitable as component (C) of the coating composition of the invention. The at least one organic solvent is preferably selected from the group consisting of mono- and polyhydric alcohols, examples being methanol, ethanol, 1-propanol, 2-propanol, 1-butanol, isobutanol, methoxypropanol, ethylene glycol, ethyl glycol, propyl glycol, butyl glycol, butyl diglycol, 1,2-propanediol and/or 1,3-propanediol, ethers, as for example diethylene glycol dimethyl ether, aliphatic hydrocarbons, aromatic hydrocarbons, as for example toluene and/or xylenes, ketones, as for example acetone, N-methylpyrrolidone, N-ethylpyrrolidone, methyl isobutyl ketone, isophorone, cyclohexanone, and methyl ethyl ketone, esters, as for example methoxypropyl acetate, ethyl acetate, butyl glycol acetate, and butyl acetate, amides, as for example dimethylformamide, and mixtures thereof.

The coating composition of the invention preferably comprises the at least one organic solvent (C) in an amount of 5 to 60 wt %, more preferably of 10 to 55 wt %, very preferably of 15 to 50 wt %, more preferably still of 20 to 40 wt %, based in each case on the total weight of the coating composition.

### Further Optional Components (D)

The coating composition of the invention may optionally comprise at least one further component (D).

Said at least one further component (D) is preferably selected from the group consisting of pigments other than the anticorrosion pigment (B); fillers, antioxidants, antistats, wetting and dispersing agents, antisettling agents, emulsifiers, flow control assistants, solubilizers, defoaming agents, wetting agents, stabilizing agents, UV and/or light stabilizers, photoprotectants, deaerating agents, inhibitors, catalysts, waxes, flexibilizers, flame retardants, hydrophobizing agents, hydrophilizing agents, thixotropic agents, impact modifiers, processing auxiliaries, plasticizers, and mixtures of the aforementioned components. The amount of (D) in the coating composition of the invention may vary very widely according to the intended use. The amount of the at least one component (D) is preferably 0.01 to 20.0 wt %, more preferably 0.05 to 18.0 wt %, very preferably 0.1 to 16.0 wt %, especially preferably 0.1 to 14.0 wt %, more particularly 0.1 to 12.0 wt %, and most preferably 0.1 to 10.0 wt %, based in each case on the total weight of the coating composition of the invention.

The term “pigment” is known to the skilled person, from DIN 55945 (date: October 2001), for example. A “pigment” within the meaning of the present invention refers preferably to compounds in powder or platelet form which are insoluble substantially, preferably completely, in the medium surrounding them, such as in the coating composition of the invention. Pigments differ from “fillers” preferably in their refractive index, which for pigments is 1.7.

Suitability as pigments different from the anticorrosion pigment (B) is possessed preferably by pigments selected from the group consisting of organic and inorganic color-imparting pigments, effect pigments and mixtures thereof. Examples of suitable inorganic color-imparting pigments are white pigments such as zinc white, zinc sulfide or lithopone; black pigments such as carbon black, iron manganese black, or spinel black; chromatic pigments such as chromium oxide, chromium oxide hydrate green, cobalt green or ultramarine green, cobalt blue, ultramarine blue or manganese blue, ultramarine violet or cobalt violet and manganese violet, red iron oxide, cadmium sulfoselenide, molybdate red or ultramarine red; brown iron oxide, mixed brown, spinel phases and corundum phases or chromium orange; or yellow iron oxide, nickel titanium yellow, chromium titanium yellow, cadmium sulfide, cadmium zinc sulfide, chromium yellow, or bismuth vanadate. Examples of further inorganic color-imparting pigments are silicon dioxide, aluminum oxide, aluminum oxide hydrate, in particular boehmite, titanium dioxide, zirconium oxide, cerium oxide and mixtures thereof. Examples of suitable organic color-imparting pigments are monoazo pigments, disazo pigments, anthraquinone pigments, benzimidazole pigments, quinacridone pigments, quinophthalone pigments, diketopyrrolopyrrole pigments, dioxazine pigments, indanthrone pigments, isoindoline pigments, isoindolinone pigments, azomethine pigments, thioindigo pigments, metal complex pigments, perinone pigments, perylene pigments, phthalocyanine pigments, or aniline black.

The term “filler” is known to the skilled person, from DIN 55945 (date: October 2001), for example. A “filler” within the meaning of the present invention refers preferably to a substance which is substantially insoluble, preferably completely insoluble, in the coating composition of the invention, and is used more particularly for increasing the volume. “Fillers” within the meaning of the present invention preferably differ from “pigments” in their refractive index, which for fillers is <1.7. Any customary filler known to the skilled person may be used. Examples of suitable fillers are kaolin, dolomite, calcite, chalk, calcium sulfate, barium sulfate, graphite, silicates such as magnesium silicates, more particularly corresponding phyllosilicates such as hectorite, bentonite, montmorillonite, talc and/or mica, silicas, more particularly fumed silicas, hydroxides such as aluminum hydroxide or magnesium hydroxide, or organic fillers such as textile fibers, cellulose fibers, polyethylene fibers, or polymer powders; for further details refer to Rompp Lexikon Lacke and Druckfarben, Georg Thieme Verlag, 1998, pages 250 ff., “Fillers”.

The present invention additionally provides a process for producing the coating composition of the invention. The process of the invention comprises at least the step of the mixing of components (A), (B), and (C), and optionally (D).

This step of the process of the invention is carried out preferably by means of a high-speed stirrer, a dissolver or an inline dissolver.

Use for the at Least Partial Coating of a Metallic Substrate with a Primer Coat

The coating composition of the invention is suitable as a primer coat for application to a substrate which may have been at least partly coated.

The present invention accordingly further provides for use of the coating composition of the invention for the at least partial coating of a preferably metallic substrate with a primer coat.

All preferred embodiments described hereinabove in connection with the coating composition of the invention are also preferred embodiments of the coating composition used in accordance with the invention in relation to its use for the at least partial coating of a substrate with a primer coat.

The coating composition of the invention is employed preferably for the at least partial coating, with a primer coat, of substrates which are used in aircraft construction, ship building and/or boat building, in other words, in particular, for the corresponding coating of substrates which are employed for producing aircraft, ships and/or boats, especially aircraft.

Method for the at Least Partial Coating of a Substrate with a Primer Coat

The present invention further provides a method for the at least partial coating of a metallic substrate with a primer coat, comprising at least a step (1),
(1) at least partly contacting the metallic substrate with the coating composition of the invention.

The term “contacting” in the sense of the present invention refers preferably to the immersion of the substrate for at least partial coating with the coating composition of the invention into the coating composition employed; the spraying of the substrate for at least partial coating with the coating composition; or roller application of the coating composition onto the substrate for at least partial coating. More particularly, in the context of the present invention, the term “contacting” refers to spraying of the substrate to be at least partially coated with the coating composition.

Such spraying may take place by electrostatic spraying, by air-spray coating or by airless spray coating. The dry film thickness of the resultant coating film falls preferably within a range from 5 to 35 μm, more particularly 10 to 25 μm, as cured coating film. The coating film may be cured, for example, by heating it at 15 to 40° C. for 10 to 40 minutes.

All preferred embodiments described hereinabove in connection with the coating composition of the invention are also preferred embodiments of the coating composition of the invention used in the method of the invention for the at least partial coating of a substrate with a primer coat.

Method for the at Least Partial Coating of a Substrate with a Multicoat Paint System

The present invention further provides a method for the at least partial coating of a substrate with a multicoat paint system, comprising at least the steps of
(1) at least partly contacting the metallic substrate with the coating composition of the invention for the at least partial application of a primer coat to the substrate, and
(2) applying a further coat, preferably a topcoat or a clearcoat, to the primer coat applied by step (1).

All preferred embodiments described hereinabove in connection with the coating composition of the invention are also preferred embodiments of the coating composition of the invention used in the method of the invention for the at least partial coating of a substrate with a multicoat paint system.

A further coat, more particularly a topcoat or clearcoat, most preferably a topcoat, is customarily applied to the primer coat applied as per step (1). The primer coat is preferably dried prior to the application of the further coat as per step (2). The term “drying” refers, in the context of the present invention, preferably to the removal of solvent from the applied coating material. Drying may take place initially at 15 to 40° C. for 10 to 40 minutes. With particular preference, drying is carried out for a time of 1 to 24 hours, preferably at 15 to 40° C., before step (2) is carried out.

The general techniques for applying the further coat as per step (2) are in line with those described earlier on above for the primer coat. The further coat, such as the topcoat, is applied in the customary and known film thicknesses, as for example in dry film thicknesses after curing in the range from 15 to 100 micrometers, more particularly 40 to 80 or 50 to 75 micrometers.

The curing takes place in accordance with the customary and known techniques such as, for example, heating in a forced air oven or by irradiation with IR lamps. Also possible is actinic curing by means of UV radiation, for example, in the case of radiation-curing systems. The curing conditions, particularly the curing temperatures, are guided, for example, by the temperature sensitivity of the substrates used or by the choice of the binders employed. Hence curing may take place, for example, in the range of room temperature (20 to 23° C.) or else at elevated temperatures in the range of, for example, 40° C. to 120° C., preferably of 60° C. to 90° C. The duration of the curing phase as well is selected individually and is dependent on factors including those already specified (for example, choice of binders and/or of curing temperatures). For example, curing may take place over a period of 5 to 120 minutes, preferably 10 minutes to 40 minutes. Curing may optionally also be preceded by a flashing phase or preliminary drying phase, at room temperature for a duration of 1 to 60 minutes, for example. Particular preference is given to drying or curing, preferably at 15 to 40° C., for a duration of 1 to 168 hours after step (2) has been carried out. Which curing conditions are to be employed with which substrates and/or coating compositions is part of the general art knowledge in the field, and so the skilled person is able to select and adapt the conditions.

Further provided by the present invention is a multicoat paint system obtainable by the method of the invention.

The present invention additionally provides a metallic substrate at least partially coated with the coating composition of the invention. The present invention further provides a component or article produced from at least one such at least partially coated substrate.

### Methods of Determination

### 1. Filiform Corrosion According to DIN EN 3665

Determination of filiform corrosion is used for ascertaining the corrosion resistance of a coating on a substrate. This determination is made in accordance with DIN EN 3665 (date: August 1997) for the aluminum-based substrate (ALU), coated with an inventive coating composition or comparative coating composition, over a duration of 1000 h or 3000 h. It involves the respective coating, starting from a line of induced damage to the coating, being undermined by a corrosion that takes the form of a line or thread. The maximum and average thread lengths in [mm] are measured according to DIN EN 3665 (method 3). The maximum and average thread lengths are a measure of the corrosion resistance of the coating.

### 2. Determination of Nonvolatile Fraction

The nonvolatile fraction is determined according to DIN EN ISO 3251 (date: June 2008). This involves weighing out 1 g of sample into an aluminum boat which has been dried beforehand, and drying the sample in a drying oven at 130° C. for 60 minutes, cooling it in a desiccator, and then weighing it again. The residue, based on the total amount of sample used, corresponds to the nonvolatile fraction.

### 3. Cross-Cut Testing

The cross-cut test serves to determine the strength of adhesion of a coating on a substrate. The cross-cut test is carried out according to DIN EN ISO 2409 (date: August 2007) for the substrates coated with an inventive coating composition or with a comparative coating composition, more particularly aluminum-based substrates (ALU), to which a topcoat is also applied over the coating. The cross-cut test is conducted before and after a DIN EN ISO 6270-2 CH constant humidity test (date: September 2005). Here, the samples under investigation are exposed continuously in a constant humidity test chamber (CH) over a duration of 500 hours to an atmosphere of 40° C. and 100% humidity. Assessment is made on the basis of characteristic cross-cut values in the range from 0 (very good adhesive strength) to 5 (very poor adhesive strength).

### 4. Adhesive Strength

The adhesive strength is determined according to DIN EN ISO 4624 (date: August 2003). The adhesive strength here is determined by tearing off a topcoat from a primer coat applied to a substrate (the primer coat being obtained using an inventive coating composition or a comparative coating composition), by measurement of the minimum tensile strain required to separate or tear off this coating perpendicularly from the primed substrate.

The inventive and comparative examples which follow serve to elucidate the invention, but should not be interpreted as imposing any restriction.

### INVENTIVE AND COMPARATIVE EXAMPLES

Unless otherwise noted, the amounts in parts are parts by weight, and the amounts in percent are in each case percentages by weight.

### 1. Preparation of Inventive Coating Compositions

### 1.1 Preparation of a Crosslinker Composition H

The components listed in table 1 below are combined in the stated order at a temperature in the range of 18-23° C. with stirring to prepare the crosslinker composition H.

TABLE 1
Crosslinker composition H

| | Components for | Amount of | Solids fraction |
|---|---|---|---|
| | preparing crosslinker | component | of component in |
| | composition H | in H [wt %] | H [wt %] |
| 1 | Aradur ® 3204 XW29 | 51.55 | 12.89 |
| 2 | Aradur ® 115 BD | 4.6 | 4.6 |
| 3 | Cardolite ® NC 562 | 24.8 | 16.12 |
| 4 | Ancamine ® K54 | 0.2 | 0.2 |
| 5 | 3-Methoxypropanol | 6 | — |
| 6 | Isobutanol | 3.75 | — |
| 7 | Xylene | 7.5 | — |
| 8 | Diethylenetriamine | 0.6 | 0.6 |
| 9 | Solvent naphtha | 1 | — |
| | 160/180 | | |

Aradur ® 3204 XW29 is a commercially available solution of a polyamine adduct from Huntsman. It has a solids fraction of 25 wt %, based on its total weight.
Aradur ® 115 BD is a commercially available polyamidoimidazoline from Vantico, with a solids fraction of 100 wt %.
Cardolite ® NC 562 is a commercially available phenalkamine adduct from Cardolite. It has a solids fraction of 65 wt %, based on its total weight.
Ancamine ® K54 is a commercially available accelerator from Air Products, containing 2,4,6-tri(dimethyl-aminomethyl)phenol. Diethylenetriamine acts as a crosslinking agent.

The crosslinker composition H has a nonvolatile fraction of 34.41 wt %.

### 1.2 Preparation of Paint Base Compositions S1, S2, S3, S4, and S5

The components listed in table 2 below are combined in the stated order at a temperature in the range of 18-23° C. with stirring to give the respective paint base composition.

TABLE 2
Paint base compositions

| | Components for producing | | | | | |
|---|---|---|---|---|---|---|
| | the respective paint base | | | | | |
| | composition | S1 | S2 | S3 | S4 | S5 |
| 1 | Araldite ® EPN X 80/wt % | 40 | 40 | 40 | 40 | 40 |
| 2 | Araldite ® DY 3601/wt % | 10 | 10 | 10 | 10 | 10 |
| 3 | Disperbyk ® 161/wt % | 0.5 | 0.5 | 0.5 | 0.5 | 0.5 |
| 4 | Aerosil ® 972 V/wt % | 1 | 1 | 1 | 1 | 1 |
| 5 | Sipernate ® P 820 A/wt % | 1 | 1 | 1 | 1 | 1 |
| 6 | Sikron ® SF600 | — | 15 | — | — | — |
| 7 | KP1/wt % | 34.5 | 19.5 | — | — | — |
| 8 | KP2/wt % | — | — | — | 16.4 | 31.0 |
| 9 | TiO₂/wt % | — | — | 10 | 10 | 1.0 |
| 10 | Talc/wt % | — | — | 9.6 | 5.6 | — |
| 11 | Calcium carbonate/wt % | — | — | 6.0 | — | — |
| 12 | Black iron oxide | — | — | 0.4 | — | — |
| | pigment/wt % | | | | | |
| 13 | Barium sulfate/wt % | — | — | 6.0 | — | — |
| 14 | Methyl isobutyl | 3.4 | 3.4 | — | — | — |
| | ketone/wt % | | | | | |
| 15 | Methoxypropanol/wt % | — | — | 3.4 | 3.4 | 3.4 |
| 16 | Cyclohexanone/wt % | — | — | 2.5 | 2.5 | 2.5 |
| 17 | Isobutanol/wt % | 3.5 | 3.5 | 3.5 | 3.5 | 3.5 |
| 18 | Xylene/wt % | 3.7 | 3.7 | 3.7 | 3.7 | 3.7 |
| 19 | Butyl glycol acetate/wt % | 0.9 | 0.9 | 0.9 | 0.9 | 0.9 |
| 20 | Plastopal ® EBS 400/wt % | 0.6 | 0.6 | 0.6 | 0.6 | 0.6 |
| 21 | Byk ® 325/wt % | 0.4 | 0.4 | 0.4 | 0.4 | 0.4 |
| 22 | Dow Corning ® Z 6040/wt % | 0.5 | 0.5 | 0.5 | 0.5 | 0.5 |

Araldite ® EPN X 80 (DEN 438-X80) is a polymeric epoxy resin from Dow Chemicals. It has a solids fraction of 80 wt %, based on its total weight. The remaining 20 wt % is xylene.
Araldite ® DY 3601 is a polypropylene glycol-based epoxy resin from Dow Chemicals and has a solids content of 100 wt %.
Disperbyk ® 161 is a commercially available dispersant from Byk with a solids content of 30 wt %.
Aerosil ® 972 V is a commercially available hydrophobized fumed silica from Evonik, with a density of 2.7 g/cm³.
Sipernate ® P 820 A is a commercially available filler from Evonik, with a density of 2.7 g/cm³.
Sikron ® SF600 is an SiO₂-based, ultrafinely ground product from Quarzwerke Group, with a density of 2.7 g/cm³.
Plastopal ® EBS 400 is a commercially available urea-formaldehyde resin from BASF, with a solids content of 60 wt %.
Byk ® 325 is a commercially available flow control assistant from Byk, with a solids content of 52 wt %.
Dow Corning ® Z 6040 is based on glycidyloxypropyltrimethoxysilane.

The pigments and fillers used—TiO₂, talc, calcium carbonate, black iron oxide pigment, and barium sulfate—each have a density of 4.5 g/cm³.

KP1 is a composition which comprises an inventively employed anticorrosion pigment (B). KP1 contains 90.5 wt %, based on the total weight of KP1, of the anticorrosion pigment (B), 4.5 wt % of xylene, and 5.5 wt % of Terlitol®. Terlitol® (white spirit) is a commercially available solvent mixture. The anticorrosion pigment (B) contains about >20 wt % magnesium and >70 wt % zinc. The anticorrosion pigment (B) further contains at least Si as further metal and/or semimetal, in an amount <1 wt %. The density of the anticorrosion pigment (B) is 4.4 g/cm³.

KP2 is a composition which comprises an inventively employed anticorrosion pigment (B). KP2 contains 87 wt %, based on the total weight of KP2, of the anticorrosion pigment (B), and 13 wt % of Terlitol®. Terlitol® (white spirit) is a commercially available solvent mixture. The anticorrosion pigment (B) contains >20 wt % magnesium and >70 wt % zinc. The anticorrosion pigment (B) further contains at least Si as further metal and/or semimetal, in an amount <1 wt %. The density of the anticorrosion pigment (B) is 4.4 g/cm³.

### 1.3 Preparation of Paint Base Compositions S6, S7, S8, S9, and S10

The components listed in table 3 below are combined in the stated order at a temperature in the range of 18-23° C. with stirring to give the respective paint base composition.

TABLE 3
Paint base compositions

| | Components for producing | | | | | |
|---|---|---|---|---|---|---|
| | the respective paint base | | | | | |
| | composition | S6 | S7 | S8 | S9 | S10 |
| 1 | Araldite ® EPN X 80/wt % | 40 | 40 | 40 | 40 | 24.70 |
| 2 | Araldite ® DY 3601/wt % | 10 | 10 | 10 | 10 | 6.20 |
| 3 | Disperbyk ® 161/wt % | 0.5 | 0.5 | 0.5 | 0.5 | 0.30 |
| 4 | Aerosil ® 972 V/wt % | 1 | 1 | 1 | 1 | 0.61 |
| 5 | Sipernate ® P 820 A/wt % | 1 | 1 | 1 | 1 | 0.61 |
| 6 | KP1/wt % | — | 6.0 | 14.0 | 28.0 | 58.0 |
| 7 | TiO₂/wt % | 10 | 10 | — | — | — |
| 8 | Talc/wt % | 9.6 | 9.6 | 9.6 | 4.0 | — |
| 9 | Calcium carbonate/wt % | 6.0 | 6.0 | 6.0 | — | — |
| 10 | Black iron oxide | 0.4 | 0.4 | — | — | — |
| | pigment/wt % | | | | | |
| 11 | Barium sulfate/wt % | 6.0 | — | 2.40 | — | — |
| 12 | Methoxypropanol/wt % | 3.4 | 3.4 | 3.4 | 3.4 | 2.10 |
| 13 | Cyclohexanone/wt % | 2.5 | 2.5 | 2.5 | 2.5 | 1.5 |
| 14 | Isobutanol/wt % | 3.5 | 3.5 | 3.5 | 3.5 | 2.2 |
| 15 | Xylene/wt % | 3.7 | 3.7 | 3.7 | 3.7 | 2.3 |
| 16 | Butyl glycol acetate/wt % | 0.9 | 0.9 | 0.9 | 0.9 | 0.56 |
| 17 | Plastopal ® EBS 400/wt % | 0.6 | 0.6 | 0.6 | 0.6 | 0.37 |
| 18 | Byk ® 325/wt % | 0.4 | 0.4 | 0.4 | 0.4 | 0.25 |
| 19 | Dow Corning ® Z 6040/wt % | 0.5 | 0.5 | 0.5 | 0.5 | 0.30 |

### 1.4 Preparation of Inventive Coating Compositions Z1, Z2, Z3, Z4, Z5, and Z6, and of Comparative Coating Compositions V1, V2, V3, and V4

73 parts by weight in each case of the crosslinker composition H are added to 100 parts by weight of each of the paint base compositions S1, S2, S3, S4, and S5, prior to the respective application to a substrate, with stirring and at a temperature in the range of 18-23° C., to give the coating compositions Z1, Z2, Z3, Z4, and V1.

70 parts by weight in each case of the crosslinker composition H are added to 100 parts by weight of each of the paint base compositions S6, S7, S8, and S9, prior to the respective application to a substrate, with stirring and at a temperature in the range of 18-23° C., to give the coating compositions Z5 and Z6 and also V2 and V3.

50 parts by weight of the crosslinker composition H are added to 100 parts by weight of the paint base composition S10, prior to the respective application to a substrate, with stirring and at a temperature in the range of 18-23° C., to give the coating composition V4.

TABLE 4
gives a corresponding overview:

| | | | | Amount of |
|---|---|---|---|---|
| | | | | anticorrosion |
| Coating | Paint base | Crosslinker | PVC | pigment (B) |
| composition | component | composition | [%] ^{#} | [wt %] * |
| Z1 | S1 (100 | H (73 parts | 10.43 | 18.06 |
| (inventive) | parts by | by weight) | | |
| | weight) | | | |
| Z2 | S2 (100 | H (73 parts | 13.10 | 10.20 |
| (inventive) | parts by | by weight) | | |
| | weight) | | | |
| V1 (not | S3 (100 | H (73 parts | 10.29 | — |
| inventive) | parts by | by weight) | | |
| | weight) | | | |
| Z3 | S4 (100 | H (73 parts | 9.78 | 8.25 |
| (inventive) | parts by | by weight) | | |
| | weight) | | | |
| Z4 | S5 (100 | H (73 parts | 9.31 | 15.59 |
| (inventive) | parts by | by weight) | | |
| | weight) | | | |
| V2 (not | S6 (100 | H (70 parts | 10.44 | — |
| inventive) | parts by | by weight) | | |
| | weight) | | | |
| V3 (not | S7 (100 | H (70 parts | 10.32 | 3.19 |
| inventive) | part by | by weight) | | |
| | weight) | | | |
| Z5 | S8 (100 | H (70 parts | 10.17 | 7.45 |
| (inventive) | parts by | by weight) | | |
| | weight) | | | |
| Z6 | S9 (100 | H (70 parts | 9.92 | 14.91 |
| (inventive) | parts by | by weight) | | |
| | weight) | | | |
| V4 (not | S10 (100 | H (50 parts | 21.31 | 35.0 |
| inventive) | parts by | by weight) | | |
| | weight) | | | |

* The amount of anticorrosion pigment (B) reported in weight % is based in each case on the total weight of the respective coating composition.
^{#} Where no specific densities have been reported for the individual components relevant to the calculation of the PVC, the calculation is based on a density of 1.0 g/cm³ for each of these components.

Comparative coating composition V4 is a comparative example as per WO 2014/029779 A2 and WO 2014/029781 A2 (cf. basecoat as per table on page 45 of WO 2014/029781 A2 or as per the table on pages 40 and 41 of WO 2014/029779 A2): the coating compositions described therein in each case contain >25 wt % of the anticorrosion pigment described therein (and also have a PVC>25%), based on the respective coating composition.

### 2. Production of Coated Substrates Using One of the Inventive or Comparative Coating Compositions

One of the coating compositions Z1 to Z6 or one of the comparative coating compositions V1 to V4 is applied in each case as a primer coating on a metal panel substrate made from a commercially available aluminum alloy (EN AW 2024, substrate T1). Each of the compositions Z1 to Z6 or V1 to V4 is applied directly after its above-described preparation as a primer coat on each substrate.

The metal panels employed have a total area of approximately 70 cm². Each panel was pretreated by means of tartaric-sulfuric acid anodizing (TSA) as per DIN EN 4704 (date: May 2012).

One of the inventive coating compositions Z1 to Z6 is applied to one side of each substrate (T1) by spraying using a spray gun. The dry film thickness is 20-25 μm in each case. This is followed by drying through storage over 24 hours at 15-25° C.

Subsequently, a topcoat is applied to each of the resulting coated substrates, in a dry film thickness of to 80 μm, to give the coated panels T1Z1, T1Z2, T1Z3, T1Z4, T1Z5, and T1Z6, and also T1V1, T1V2, T1V3, and T1V4. The topcoat is applied using in each case the commercial product Glasurit® from the 68 line (RAL 9010), a two-component polyurethane-based topcoat material. Subsequent drying or curing took place by means of storage of the coated panels for a time of 7 days at 15-25° C.

### 3. Investigation of the Adhesion Properties and Corrosion Prevention Effect on the Coated Substrates

Investigations are carried out on the substrates T1Z1, T1Z2, T1Z3, T1Z4, T1Z5, and T1Z6, and also T1V1, T1V2, T1V3, and T1V4, coated with one of the coating compositions Z1 to Z6 and V1 to V4, respectively.

All of the tests below were carried out in accordance with the methods of determination specified above. Each value in table 5a and 5b, in which the respective results are summarized, is the average from a double or triple determination.

TABLE 5a

| | | | Adhesive | Adhesive |
|---|---|---|---|---|
| Coated | | | strength | strength |
| substrate | Adhesion¹ | Adhesion² | [N/mm²]³ | [N/mm²]⁴ |
| T1Z1 | 0 | 1 | 2.80 | 3.10 |
| T1Z2 | 0 | 0 | 3.40 | 3.60 |
| T1V1 | 0 | 0 | 3.50 | 5.03 |
| T1Z3 | 0 | 0 | 2.86 | 4.11 |
| T1Z4 | 0 | 0 | 3.09 | 3.66 |

¹Evaluation of adhesion between coating and topcoat by cross-cut test prior to constant humidity testing
²Evaluation of adhesion between coating and topcoat by cross-cut test after constant humidity testing
³Adhesive strength in [N/mm²] prior to constant humidity testing
⁴Adhesive strength in [N/mm²] after constant humidity testing

TABLE 5b

| Coated | | | |
|---|---|---|---|
| substrate | Adhesion¹ | Adhesion² | Adhesion³ |
| T1V2 | 0 | 0 | 4.04 |
| T1V3 | 0 | 0 | 5.48 |
| T1Z5 | 0 | 0 | 5.54 |
| T1Z6 | 0 | 0 | 4.46 |
| T1V4 | 1 | 5 | — * |

¹Evaluation of adhesion between coating and topcoat by cross-cut test prior to constant humidity testing
²Evaluation of adhesion between coating and topcoat by cross-cut test after constant humidity testing
³Adhesive strength in [N/mm²] after constant humidity testing
* Delamination of the topcoat from the coated substrate is observed.

As can be seen from table 5b, with a comparative coating composition V4 (as per WO 2014/029779 A2 and WO 2014/029781 A2), with a comparatively high pigment content in terms of anticorrosion pigment described therein, of >25 wt %, and with a PVC>25%, after the constant humidity testing has been carried out, it is no longer possible to observe sufficient adhesion of the topcoat on the substrate T1 coated with the inventive coating composition, since there is delamination or inadequate adhesion after the cross-cut test conducted. In contrast, the coating compositions of the invention, with an anticorrosion pigment (B) content in a range from 5.0 to 25.0 wt % and with a PVC in the range from 5.0 to 25.0%, are notable for effective adhesion properties even under these conditions.

While corresponding adhesion properties can be obtained using V2 (no anticorrosion pigment (B)) and V3 (anticorrosion pigment (B) content <5 wt %), sufficient corrosion prevention is no longer achieved with these comparative coating compositions, when set against the inventive coating compositions, as table 5c makes clear:

TABLE 5c

| | Maximum thread |
|---|---|
| | length [mm] after |
| Coated | 1000 h of filiform |
| substrate | corrosion |
| T1V2 | 11.2 |
| T1V3 | 10.2 |
| T1Z5 | 7.39 |
| T1Z6 | 6.45 |

1: A coating composition, comprising:
at least one binder (A) comprising at least one polymeric resin (A1) and at least one crosslinking agent (A2),
at least one anticorrosion pigment (B), and
at least one organic solvent (C), and
optionally at least one further component (D),
wherein the anticorrosion pigment (B) is an alloy of zinc and magnesium and optionally at least one further metal and/or semimetal, and comprises zinc in an amount of at least 70 wt %, magnesium in an amount of at least 20 wt %, and the optionally present at least one further metal and/or semimetal in an amount of at most 10 wt %, based in each case on the total weight of the anticorrosion pigment (B), where the amounts in % by weight of zinc, of magnesium, and of the optionally present at least one further metal and/or semimetal that are present in the anticorrosion pigment (B) add up in total to 100 wt %,
wherein the coating composition has a pigment volume concentration (PVC) in a range from 5.0% to 25.0%, and
wherein the coating composition comprises the anticorrosion pigment (B) in an amount in a range from 5.0 to 25.0 wt %, based on the total weight of the coating composition.

2: The coating composition as claimed in claim 1, wherein the coating composition has a pigment volume concentration (PVC) in a range from 5.0% to 20.0%.

3: The coating composition as claimed in claim 1, wherein the coating composition comprises the anticorrosion pigment (B) in an amount in a range from 5.0 to <20.0 wt %, based on the total weight of the coating composition.

4: The coating composition as claimed in claim 1, wherein the relative weight ratio of the anticorrosion pigment (B) to further, different pigments and fillers optionally present in the coating composition is in a range from 25:1 to 1:5.

5: The coating composition as claimed in claim 1, wherein the relative weight ratio of the at least one binder (A), based on the solids fraction of the binder (A) in the coating composition, and of the at least one anticorrosion pigment (B) in the coating composition to one another is in a range from 5:1 to 1.5:1.

6: The coating composition as claimed in claim 1, wherein the anticorrosion pigment (B) is an alloy of zinc and magnesium and optionally at least one further metal and/or semimetal, and comprises zinc in an amount in a range from 70 wt % to 80 wt %, magnesium in an amount in a range from 20 wt % to 30 wt %, and the optionally present at least one further metal and/or semimetal in an amount in a range from 0.1 to 8 wt %, based in each case on the total weight of the anticorrosion pigment (B), and the amounts in weight % of zinc, of magnesium, and of the optionally present at least one further metal and/or semimetal that are present in the anticorrosion pigment (B) adding up in total to 100 wt %.

7: The coating composition as claimed in claim 1, wherein at least 70 to 100 mol % of the further metal and/or semimetal present in the anticorrosion pigment (B) are selected from the group consisting of Li, Ce, Be, Y, Ti, Zr, Cr, Mn, Fe, Cu, B, Al, Si, and Sn, and also mixtures thereof.

8: The coating composition as claimed in claim 1, wherein the anticorrosion pigment (B) is platelet-shaped and has an average particle size D₅₀ in the 1 to 50 μm range and an average platelet thickness in the range from 50 to 750 nm.

9: The coating composition as claimed in claim 1, wherein the binder (A) comprises at least one polymeric epoxy resin (A1) and at least one crosslinking agent (A2) having at least functional amino groups.

10: The coating composition as claimed in claim 1, wherein the binder (A) comprises at least two different polymeric epoxy resins (A1) and/or at least two different crosslinking agents (A2) having at least functional amino groups.

11: The coating composition as claimed in claim 1, wherein the at least one crosslinking agent (A2) has functional silane groups.

12. (canceled)

13: A method for the at least partial coating of a metallic substrate with a primer coat, the method comprising:
(1) at least partly contacting the metallic substrate with the coating composition as claimed in claim 1.

14: A method for the at least partial coating of a substrate with a multicoat paint system, the method comprising:
(1) at least partly contacting the metallic substrate with the coating composition as claimed in claim 1 for the at least partial application of a primer coat to the substrate, and
(2) applying a topcoat to the primer coat applied during (1).

15: A metallic substrate at least partially coated with the coating composition as claimed in claim 1.
